(19) United States
(12) Patent Application Publication
(10) Pub. No.: US 2026/0210388 A1
(43) Pub. Date: Jul. 23, 2026

(54) LINKAGE LOCKING ASSEMBLY, TRUSS, AND WORKSTATION

(71) Applicant: TILTA INC., Burbank, CA (US)

(72) Inventors: Weihan SHE, Shenzhen (CN); Wenping ZENG, Shenzhen (CN); Kefeng ZHOU, Shenzhen (CN)

(21) Appl. No.: 19/455,020

(22) Filed: Jan. 21, 2026

(30) Foreign Application Priority Data
Jan. 22, 2025 (CN) 202520155868.2

(51) Int. Cl. F16B 9/02

(52) U.S. Cl. CPC F16B 9/02

(57) ABSTRACT

A linkage locking assembly includes a clamping assembly with a first clamping member and a second clamping member. The first clamping member and the second clamping member enclose an accommodation space for housing a first object. One end of the first clamping member is connected to the second clamping member, while the other end is movable, creating an opening between the movable end and the second clamping member. A locking assembly includes a first locking portion and a second locking portion, with the second locking portion being movably positioned on the second clamping member. The first locking portion is swingably connected to the second locking portion and can assume a first position and a second position along its swing path. The locking assembly can facilitate the easy and rapid connection of the first object to a second object.

### CROSS-REFERENCE TO RELATED APPLICATIONS

The present application for patent claims priority to and the benefit of pending Chinese Application No. 202520155868.2, filed Jan. 22, 2025, and hereby expressly incorporated by reference herein as if fully set forth below in its entirety and for all applicable purposes.

### TECHNICAL FIELD

The present disclosure pertains to the technical field of extension accessories, specifically involving a linkage locking assembly, a truss, and a workstation.

### INTRODUCTION

In daily life, mobile workstations serve as auxiliary vehicles, typically suitable for work and outdoor activities. For instance, users can load photographic accessories onto a mobile workstation in certain shooting scenarios.

a mobile workstation generally includes multiple support columns and multiple layers of storage platforms connected by these support columns. Wheels can be installed at the bottom of the lowest storage platform, enabling easy movement of the mobile workstation. Each storage platform can be connected to extension accessories, such as truss beams, via the support columns. The truss beams and support columns form a truss, and the truss beams feature corresponding equipment interfaces for the extended installation of photographic accessories on the mobile workstation. Generally, one of the support column or truss beam serves as the first object, while the other serves as the second object. These two objects can be connected via an adapter connector. One end of the adapter connector locks the support column with one locking member, and the other end locks the truss beam with another locking member. Connecting the truss beam and support column using such an adapter connector requires at least two locking operations, making it relatively inconvenient to use.

### SUMMARY

Aspects of the present disclosure provide a linkage locking assembly, a truss, and a workstation to achieve convenient and rapid connection between a first object and a second object.

In the first aspect, the linkage locking assembly provided by the present disclosure is designed for connecting a first object and a second object, including:
a clamping assembly, including a first clamping member and a second clamping member, which enclose an accommodation space for housing the first object; one end of the first clamping member is connected to the second clamping member, while the other end is movable relative to the second clamping member; an opening is formed between the movable end and the second clamping member to allow the first object to enter or exit the accommodation space; and
a locking assembly, including a first locking portion and a second locking portion, with the second locking portion being movably positioned on the second clamping member; the first locking portion is swingably connected to the second locking portion and can assume a first position and a second position along its swing path; when in the first position, the first locking portion can lock the movable end, causing the clamping assembly to clamp the first object and driving the second locking portion to lock the second object onto the second clamping member; when in the second position, the first locking portion avoids the movable end, allowing the opening to open and close.

In the second aspect, the present disclosure provides a truss, including a support column serving as the first object and a truss beam serving as the second object; the truss beam is connected to the support column via the linkage locking assembly, which is the linkage locking assembly described in any of the above technical solutions.

In the third aspect, the present disclosure provides a workstation, including a truss and multiple storage platforms; the truss is the truss described in any of the above technical solutions; the multiple storage platforms are arranged in layers supported by the support columns of the truss.

### Beneficial Effects of the Present Disclosure

When using the linkage locking assembly of the present disclosure to connect the first object and the second object, the first locking portion can first be swung to the second position. At this point, the movable end of the first clamping member can move relative to the second clamping member to open the opening, allowing the first object to conveniently enter the accommodation space. Compared to clamping assemblies that must be slipped over the first object, the structure of the present disclosure improves the convenience of the first object entering the accommodation space. After the first object enters the accommodation space, swinging the first locking portion back to the first position, due to the connection and linkage between the first locking portion and the second locking portion, enables simultaneous locking of both the first object and the second object, improving the efficiency and convenience of connecting them.

### BRIEF DESCRIPTION OF THE DRAWINGS

FIG. 1 is a schematic diagram illustrating a workstation according to some aspects of the disclosure;

FIG. 2 is a schematic diagram illustrating a truss of the workstation according to some aspects of the disclosure;

FIG. 3 is a schematic diagram illustrating a linkage locking assembly of the workstation according to some aspects of the disclosure;

FIG. 4 is a cross-sectional view of the linkage locking assembly of the workstation according to some aspects of the disclosure;

FIG. 5 is a schematic diagram illustrating the locking assembly in the linkage locking assembly of the workstation according to some aspects of the disclosure;

FIG. 6 is a schematic diagram illustrating the second clamping member in the linkage locking assembly of the workstation according to some aspects of the disclosure;

FIG. 7 is a schematic diagram illustrating the second clamping member from another perspective in the linkage locking assembly of the workstation according to some aspects of the disclosure;

FIG. 8 is a schematic diagram illustrating the first clamping member in the linkage locking assembly of the workstation according to some aspects of the disclosure;

FIG. 9 is a schematic diagram illustrating a locking block in the linkage locking assembly of the workstation according to some aspects of the disclosure;

FIG. 10 is a cross-sectional view of the linkage locking assembly of the workstation according to some aspects of the disclosure;

FIG. 11 is a schematic diagram illustrating a pressing member in the linkage locking assembly in one embodiment of the workstation according to some aspects of the disclosure.

List of reference numerals and corresponding feature names in the drawings:
10. truss; 11. support column; 12. truss beam; 13. locking assembly;
131. first clamping member; 132. second clamping member; 133. accommodation space; 134. movable end; 135. opening; 136. locking groove; 137. mounting groove; 138.
locking block; 139. recess; 1310. groove bottom; 1311. groove structure; 1312. fixed pin; 1313. connecting rod; 1314. pressing member; 1315. passage; 1316. notch structure; 1317. annular flange; 1318. washer; 1319. retaining ring; 1320. wrench; 1321. mounting section; 1322. inner flange; 1323. anti-retraction member; 1324. spring; 1325. spring accommodation groove; 1326. leaf spring; 1327. recessed groove; 1328. bent portion; 1329. external hexagonal structure; 1330. return spring; 140. first locking portion
141. second locking portion;
20. storage platform;
30. wheel.

### DETAILED DESCRIPTION

In some aspects of the present disclosure, in the truss of the workstation, the truss beam and the support column are connected via a linkage locking assembly. In the linkage locking assembly, the first locking portion can swing relative to the second locking portion. The movable end of the first clamping member can move relative to the second clamping member, forming an opening communicating with the accommodation space between the movable end and the second clamping member. During use, the first locking portion is swung to the second position, allowing the first object to enter the accommodation space through the opening. Then, the first locking portion is swung back to the first position. Due to the connection and linkage between the first locking portion and the second locking portion, the first locking portion and the second locking portion can simultaneously lock the first object and the second object, ensuring convenient and rapid connection between the first object and the second object.

Embodiments of the workstation in the present disclosure:

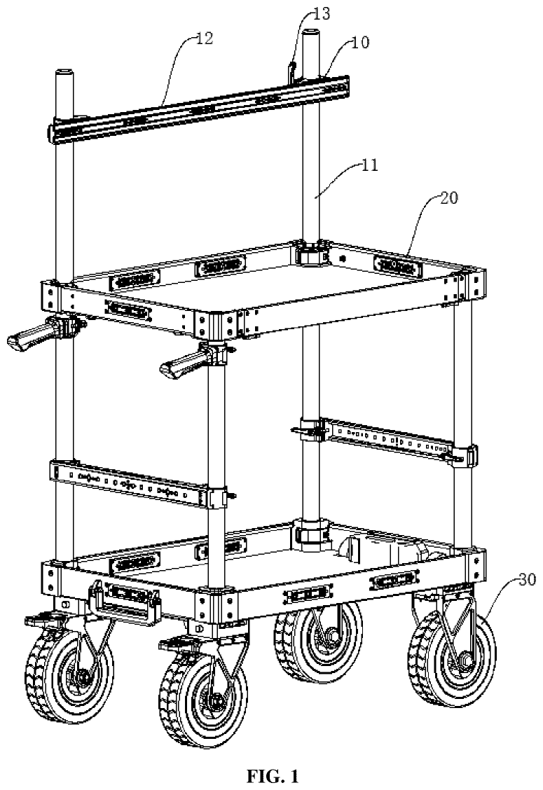

In some aspects, referring to FIG. 1, the workstation can include a truss 10 and multiple storage platforms 20. The multiple storage platforms 20 are arranged in layers vertically. Wheels 30 are installed below the bottom storage platform 20, making the workstation a mobile workstation. In some aspects, the workstation may not have wheels 30, serving as a workstation for long-term use at a fixed location. Such a workstation can also be moved, but by carrying.

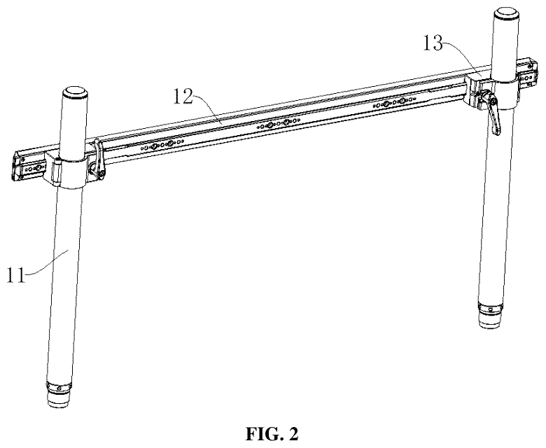

Referring to FIGS. 1 and 2. The truss 10 can include support columns 11, truss beams 12, and linkage locking assemblies 13. Both ends of a truss beam 12 are connected to two support columns 11 via two sets of linkage locking assemblies 13. That is, the support column 11 serves as the first object, and the truss beam 12 serves as the second object. The two objects are connected via the linkage locking assembly 13.

The truss beam 12 has photographic interfaces for connecting external photographic accessories, including but not limited to NATO interfaces, threaded interfaces, Arca-type quick-release plates, and cold shoe interfaces. One truss beam 12 may have one or more interfaces of a single type or multiple interfaces of different types. The specific structure of the truss beam 12 belongs to the prior art and will not be elaborated here.

The support columns 11 are cylindrical and are arranged according to the positional relationship of the four vertices of a rectangle. Two storage platforms 20 are arranged in layers, supported by the four support columns 11. Among them, two support columns 11 extend upward beyond the top storage platform 20, and one truss beam 12 is connected between these two support columns 11. Regarding the structure of the support columns 11, as understood by those skilled in the art, the cross-sectional shape of the support column can be changed, such as to rectangular, elliptical, pentagonal, etc., and it can be a solid column or a hollow column.

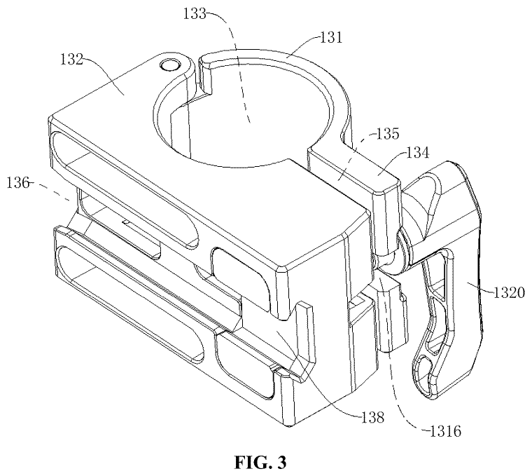

Referring to FIG. 3 for the structure of the linkage locking assembly 13. It can include a clamping assembly and a locking assembly. The clamping assembly can include a first clamping member 131 and a second clamping member 132. The two clamping members enclose an accommodation space 133 for housing the first object, i.e., the support column 11. Based on the cylindrical structure of the support column 11, the opposing faces of the two clamping members have arc-shaped recesses. The two arc-shaped recesses cooperate to form a passage-like accommodation space 133 with a circular cross-section. The reference numeral lead lines pointing to spatial structures in the drawings are drawn with dashed lines.

In some aspects, provided that the two clamping members can clamp the first object, on the opposing faces of the two clamping members, only one face can have a recess, while the other face can be designed as a planar structure, so that the recess can have a greater depth to ensure the two clamping members can reach a closed state.

One end of the first clamping member 131 is connected to the second clamping member 132, and the other end is a movable end 134 movable relative to the second clamping member 132. An opening 135 is formed between the movable end 134 and the second clamping member 132, allowing the support column 11 to enter or exit the accommodation space 133 through the opening 135 (e.g., a hole). Thus, the support column 11 enters and exits the accommodation space 133 radially. Compared to structures where the clamping assembly can only be sleeved onto the support column 11 axially, the structure of the clamping assembly in the present disclosure facilitates its combination and installation with the support column 11, improving the convenience of installing the truss beam 12 on the support column 11.

Regarding the connection method between one end of the first clamping member 131 and the second clamping member 132, in some aspects, one end of the first clamping member 131 is hinged to the second clamping member 132, with the axis of the articulated shaft extending vertically. In other aspects, a connection ring can be provided on one of the corresponding ends of the first clamping member 131 and the second clamping member 132, and a connection hook can be provided on the other, achieving connection by hooking the connection hook into the connection ring. If the truss beam 12 is not frequently disassembled and assembled, the corresponding ends of the first clamping member and the second clamping member can be integrally formed and connected as a single piece, by thinning the transition connection area between the first clamping member and the second clamping member to make it easily deformable, ensuring the movable end of the first clamping member can move smoothly.

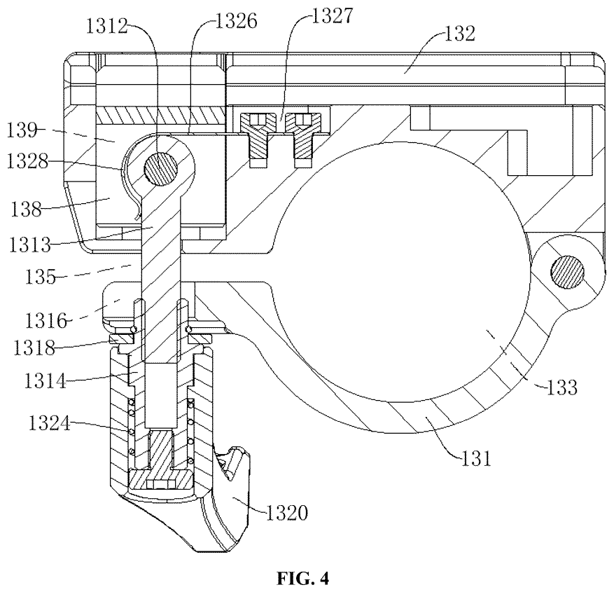

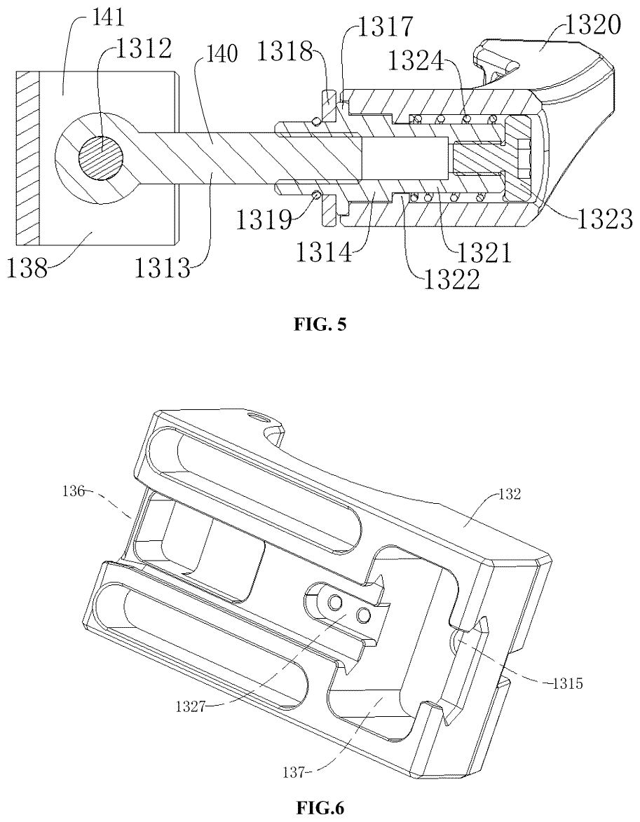

Referring to FIGS. 4 and 5, the locking assembly has a first locking portion 140 and a second locking portion 141. The second locking portion 141 is movably disposed on the second clamping member 132, and the first locking portion 140 is swingably connected to the second locking portion 141, enabling the first locking portion 140 to have a first position and a second position along its swing path. When in the first position, the first locking portion 140 can pressingly cooperate with the movable end 134, locking the movable end 134 of the first clamping member 131, enabling the clamping assembly to clamp the support column 11. It drives the second locking portion 141 to move, locking the truss beam 12 onto the second clamping member 132. When in the second position, the first locking portion 140 avoids the movable end 134, allowing the first clamping member 131 to move to open and close, achieving the opening and closing of the opening 135. This enables the support column 11 to enter or exit the accommodation space 133 via the opening 135.

Referring to FIG. 6, the second clamping member 132 has a locking groove 136 for accommodating and locking the truss beam 12. The locking groove 136 is located on a side of the second clamping member 132 facing away from the first clamping member 131. The cross-sectional shape of the locking groove 136 matches the cross-sectional shape of the part of the truss beam 12 that connects and cooperates with the linkage locking assembly 13, preventing the truss beam 12 from disengaging from the locking groove 136. In some aspects, the cross-section of the part of the truss beam 12 that connects and cooperates with the linkage locking assembly 13 is hexagonal. Therefore, the locking groove 136 is a constricted groove with a small opening leading to a larger cavity. The blocking action of the groove opening edge prevents the part of the truss beam 12 connecting with the linkage locking assembly 13 from disengaging from the locking groove 136.

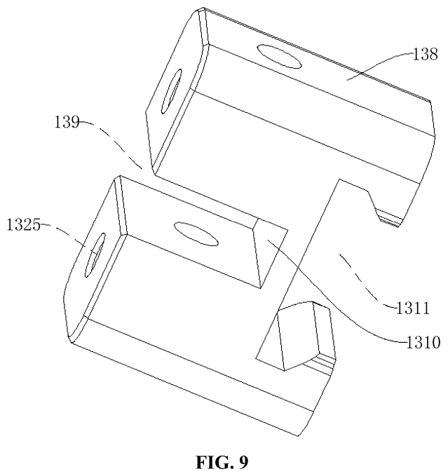

A mounting groove 137 is also provided on the second clamping member 132, communicating with the locking groove 136. The second locking portion 141 can include a locking block 138 disposed within the mounting groove 137. The locking block 138 is capable of sliding within the mounting groove 137. Referring to FIG. 9, the locking block 138 features a recess 139. The recess 139 is open on three sides, with an opening facing the first locking portion 140 and a groove bottom 1310 opposite to that opening. On the side of the locking block 138 facing away from the first locking portion 140, there is a mounting cavity for inserting the truss beam 12, enabling the second locking portion 141 to carry and move the truss beam 12 and pressingly lock it onto the second clamping member 132. In one embodiment, the mounting cavity is a groove structure 1311 with the same shape as the locking groove 136. Thus, during use, the truss beam 12 passes through both the locking groove 136 and the groove structure 1311 on the locking block 138. By moving the locking block 138 into the mounting groove 137, the truss beam 12 can be locked onto the second clamping member 132. The second locking portion 141 can further include a fixed pin 1312 fixed to the locking block 138. The fixed pin 1312 passes through the recess 139. In other embodiments, the mounting cavity can also be a circumferentially enclosed through-hole. Those skilled in the art will also understand that the locking groove 136 may not be provided on the second clamping member. In such cases, the truss beam 12, driven by the second locking portion 141, can be pressed against a planar surface at the end of the second clamping member for locking.

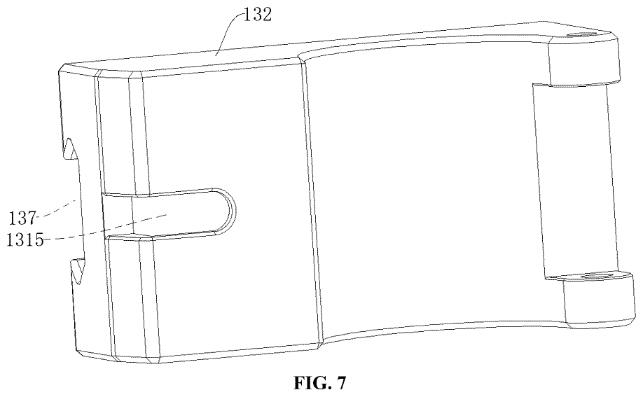

Referring to FIGS. 4 and 5, the first locking portion 140 can include a connecting rod 1313 and a pressing member 1314. One end of the connecting rod 1313 is a hinge end, which is rotatably connected to the fixed pin 1312 to form a hinge structure, achieving the hinged connection between the connecting rod 1313 and the locking block 138. This, in turn, enables the swingable connection of the first locking portion 140 to the second locking portion 141. Referring to FIGS. 6 and 7, the second clamping member 132 is provided with a passage 1315 communicating with the mounting groove 137. The connecting rod 1313 extends through the passage 1315, and its extending end features a threaded structure. The pressing member 1314 is threadedly connected to the connecting rod 1313. This configuration enables the first connecting assembly and the second connecting assembly to be arranged for relative movement towards each other. Specifically, by rotating the pressing member 1314, it can move along the connecting rod 1313 towards the locking block 138. When the pressing member 1314 reaches a position cooperating with the first clamping member 131, it can, via the connecting rod 1313, pull the locking block 138 in reverse towards the pressing member 1314, enabling the first locking portion 140 and the second locking portion 141 to move relatively towards each other, achieving the linkage of the two parts of the locking assembly.

In some aspects, the connecting rod 1313 can also be connected to the second locking portion 141 via a ball-and-socket joint structure.

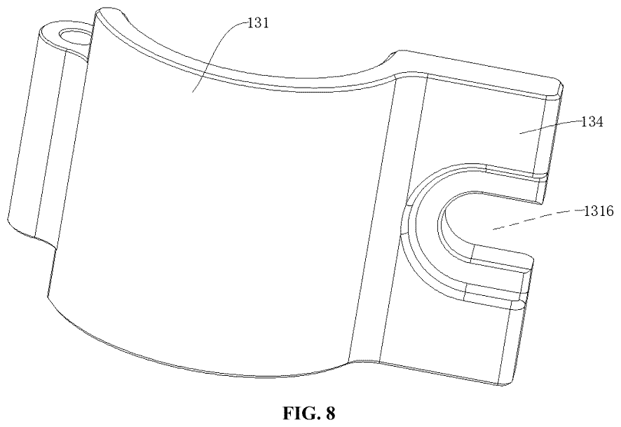

Referring to FIG. 8, to facilitate the cooperation between the pressing member 1314 and the first clamping member 131, a notch structure 1316 is provided at the movable end of the first clamping member 131. When the first locking portion 140 moves towards the first position, the notch structure 1316 can avoid the connecting rod 1313. After the first locking portion 140 reaches the first position, the connecting rod 1313 is located within the notch structure 1316.

Referring to FIG. 11, the pressing member 1314 is a tubular structure. One end of the tubular portion has internal threads for threaded connection with the connecting rod 1313. The outer peripheral surface of the tubular portion of the pressing member 1314 also features an annular flange 1317. The pressing member 1314 can further include a washer 1318 disposed on the side of the annular flange 1317 facing the second locking portion 141. The washer constitutes the pressing structure of the pressing member 1314 for pressingly cooperating with the movable end 134. To prevent the washer 1318 from falling off, a retaining ring 1319 is further provided on the tubular portion of the pressing member 1314 to constrain the washer 1318 between the annular flange 1317 and the retaining ring 1319. During operation, the pressing member 1314 presses against the edge of the notch structure 1316 via the washer 1318.

The connecting rod, in other embodiments, can also have a two-segment structure: one segment being rigid and the other being flexible. One end of the rigid segment threadedly cooperates with the pressing member 1314, and the other end is connected to the flexible segment. The end of the flexible segment away from the rigid segment is fixedly connected to the second locking portion 141. The deformability of the flexible segment enables the first locking portion 140 to swing relative to the second locking portion 141. To ensure the reliability of the locked state of the locking assembly, the flexible segment can be a rubber rod containing steel wires, making it bendable but inextensible in its length direction. This prevents the first locking portion 140 and second locking portion 141 from unintentionally moving apart due to elongation of the flexible segment, which could affect the locking effect.

To facilitate the rotation of the pressing member 1314, the pressing member 1314 has an external hexagonal structure 1329 located on the side of the annular flange 1317 facing away from the washer 1318. The locking assembly further includes a wrench 1320 sleeved on the pressing member 1314. The wrench 1320 has an internal hexagonal structure. The cooperation between the internal hexagonal structure and the external hexagonal structure 1329 enables the wrench 1320 to drive the rotation of the pressing member 1314.

In some aspects, the wrench 1320 is elastically and floatably mounted on the pressing member 1314. Specifically, the tubular portion of the pressing member 1314 has a mounting section 1321 extending into the wrench. The tubular structure of the wrench 1320 is sleeved over the mounting section 1321 and the external hexagonal structure 1329. Furthermore, an inner flange 1322 is provided on the inner wall of the tubular structure of the wrench 1320. An anti-retraction member 1323 is threadedly mounted onto the end of the mounting section 1321. Additionally, a spring 1324 is sleeved outside the mounting section 1321 of the pressing member 1314. Both ends of the spring 1324 respectively abut against the anti-retraction member 1323 and the inner flange 1322. This achieves the elastic and floating installation of the wrench 1320 on the pressing member 1314, improving the convenience of mounting the wrench 1320 on the pressing member 1314.

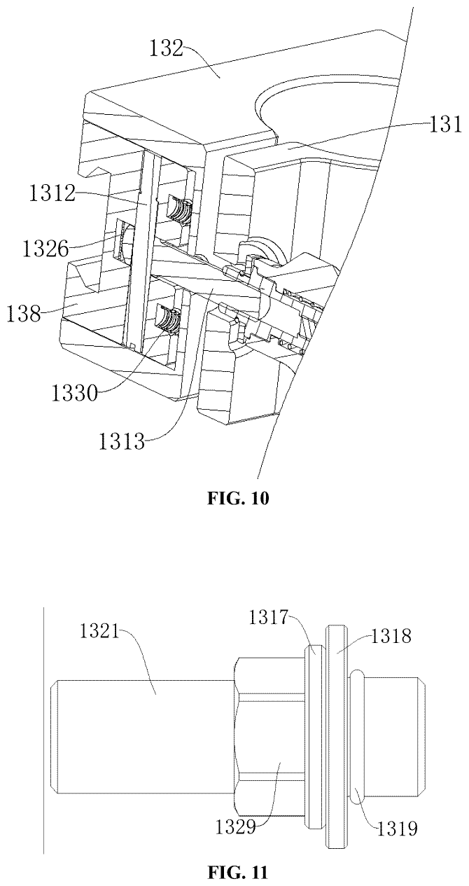

Referring to FIGS. 9 and 10, a spring accommodation groove 1325 is also provided on the end face of the locking block 138 facing the first locking portion 140. A return spring 1330 is accommodated within the spring accommodation groove 1325. The other end of the return spring 1330 abuts against the bottom of the mounting groove 137. When unlocking the truss beam 12, the return spring 1330 can drive the locking block 138 to reset, releasing the lock of the locking block 138 on the truss beam 12.

The linkage locking assembly can further include an elastic resetting member. Referring to FIG. 4, in one embodiment, the elastic resetting member is a leaf spring 1326. The bottom of the locking groove 136 has a recessed groove 1327. The recessed groove 1327 communicates with the mounting groove 137 and corresponds to the recess 139 on the locking block 138. One end of the leaf spring 1326 is fixed within the recessed groove 1327 by a screw, and the other end extends into the recess 139 of the locking block 138. Moreover, the end of the leaf spring 1326 extending into the recess 139 passes around the side of the hinge end of the connecting rod 1313 facing away from the first clamping member 131—that is, it passes between the hinge end of the connecting rod 1313 and the groove bottom 1310—and bends towards the first locking portion 140 to form a bent portion 1328. Blocking the hinge end by the leaf spring 1326 blocks the second locking portion 141. The leaf spring 1326 cooperates with the return spring 1330 in the spring accommodation groove 1325 to prevent the second locking portion 141 from shaking loosely in its unlocked state, reduce protrusion of the second locking portion 141, and avoid misalignment between the groove structure 1311 and the locking groove 136, which could affect the installation of the truss beam 12. Additionally, in the assembly stage, before the pressing member 1314 is installed on the connecting rod 1313, or when the wrench 1320 rotates causing the pressing member 1314 to detach from the connecting rod 1313, the provision of the leaf spring 1326 can prevent the locking block 138 from disengaging from the mounting groove 137. The bent portion 1328 is located on the side of the connecting rod 1313 facing the second position and can drive the first locking portion 140 to reset towards the first position. Specifically, the second locking portion 141 further has the fixed pin 1312 fixed to the locking block 138. The hinge end is rotatably connected to the fixed pin 1312 to form the hinge structure, achieving the hinged connection between the connecting rod 1313 and the locking block 138. In this context, the fixed pin 1312 is connected to the locking block 138, and the leaf spring 1326 is located between the fixed pin 1312 and the locking block 138. The leaf spring 1326 blocks the fixed pin 1312, thereby being able to block the locking block 138 to limit its position.

In some aspects, the elastic resetting member may only be used to drive the reset of the first locking portion 140and no longer used to block the second locking portion 141. In this case, the elastic resetting member can be a spring disposed on the second clamping member. One end of the spring abuts against the connecting rod 1313. When the first locking portion 140 is in the second position, the spring is compressed by the connecting rod 1313, providing a resetting force towards the first position for the first locking portion 140.

To reduce wear between the connecting rod 1313 and the elastic resetting member, in one embodiment, the surface of the connecting rod 1313 cooperating with the leaf spring 1326 is an arc-shaped surface, and the bent portion 1328 is specifically an arc-shaped bent structure.

The first locking portion 140 and the second locking portion 141 can also be configured not to move relatively towards each other; the first locking portion 140 can only swing relative to the second locking portion 141. In this case, a guiding inclined surface is provided between the first clamping member and the pressing member. When the first locking portion 140 swings towards the first position, guided by the inclined surface, the first locking portion 140 carries the second locking portion 141 to move away from the truss beam 12. When the first locking portion 140 moves to the first position, it presses the movable end 134 of the first clamping member 131, causing the clamping assembly to clamp the support column 11. Simultaneously, the second locking portion 141 locks the truss beam 12 onto the second clamping member 132.

The present disclosure also involves a truss. The structure of this truss is identical to that of the truss in the various embodiments of the workstation described above and will not be elaborated here.

The present disclosure also involves a linkage locking assembly. The structure of this linkage locking assembly is identical to that of the linkage locking assembly in the various embodiments of the workstation described above and will not be elaborated here.

The foregoing uses specific examples to explain the present disclosure, which are intended only to aid in understanding the present disclosure and not to limit it. For those skilled in the art of the present disclosure, based on the ideas of the present disclosure, several simple deductions, modifications, or substitutions can also be made.

What is claimed is:

1. An interlocking locking assembly, configured to connect a first object and a second object, comprising:
a clamping assembly, comprising a first clamping member and a second clamping member, wherein the first clamping member and the second clamping member enclose an accommodation space for accommodating the first object;
wherein one end of the first clamping member is connected to the second clamping member, and another end of the first clamping member is a movable end movable relative to the second clamping member; and
wherein an opening is formed between the movable end and the second clamping member for the first object to enter and exit the accommodation space;
a locking assembly, comprising a first locking portion and a second locking portion, wherein the second locking portion is movably disposed on the second clamping member;
wherein the first locking portion is swingably connected to the second locking portion;
wherein the first locking portion is configured with a first position and a second position in a swing stroke;
wherein, in the first position, the first locking portion is configured to lock the movable end, enabling the clamping assembly to clamp the first object and driving the second locking portion to lock the second object onto the second clamping member; and
wherein, in the second position, the first locking portion is configured to avoid the movable end, allowing the opening to open and close.

2. The interlocking locking assembly according to claim 1, wherein the interlocking locking assembly further comprises an elastic reset member disposed on the second clamping member; and
wherein the elastic reset member is configured to drive the first locking portion to reset toward the first position in response to the first locking portion being in the second position.

3. The interlocking locking assembly according to claim 2, wherein the first locking portion comprises a connecting rod;
wherein one end of the connecting rod is a hinged end and is hinged to the second locking portion via the hinged end, thereby achieving swingable connection of the first locking portion on the second locking portion;
wherein the elastic reset member comprises a leaf spring;
wherein the first end of the leaf spring is fixed on the second clamping member, and the second end of the leaf spring extends around a side of the hinged end facing away from the first clamping member, the side of hinged end is bent toward the first locking portion to form a bent portion; and
wherein the bent portion is located on a side of the first locking portion facing the second position, for driving the first locking portion to reset toward the first position.

4. The interlocking locking assembly according to claim 3, wherein the second locking portion comprises a locking block and a fixed pin;
wherein the locking block is configured to cooperate with the second clamping member to lock the second object;
wherein the fixed pin is provided on the locking block;
wherein the hinged end cooperates with the fixed pin to form a hinge structure; and
wherein one end of the leaf spring is configured to block the hinged end to thereby block the fixed pin and thus block the locking block.

5. The interlocking locking assembly according to claim 3, wherein a surface of the hinged end of the connecting rod cooperating with the leaf spring is an arc-shaped surface; and
wherein the bent portion is configured to be an arc-shaped bent structure.

6. The interlocking locking assembly according to claim 3, wherein the second clamping member is provided with a locking groove for accommodating the second object;
wherein the second locking portion is embedded in a mounting groove provided on the second clamping member;
wherein the mounting groove communicates with the locking groove;
wherein a groove bottom of the locking groove is provided with a recessed groove;
wherein the second locking portion is provided with a recess; wherein the connecting rod extends into the recess to be hinged to the second locking portion; and
wherein one end of the leaf spring is fixed in the recessed groove, while another end extends into the recess.

7. The interlocking locking assembly according to claim 3, wherein the first locking portion further comprises a pressing member;
wherein the pressing member is threadedly connected to the connecting rod, enabling relative convergent movement between the connecting rod and the pressing member by rotating the pressing member, thereby enabling relative convergent movement between the first locking portion and the second locking portion;
wherein the pressing member has a pressing structure is configured to press and coopratewith the movable end; and
wherein the second locking portion is provided with an insertion cavity for insertion of the second object, enabling the second locking portion to drive the second object to move, thereby locking the second object by pressing the second object against the second clamping member.

8. The interlocking locking assembly according to claim 1, wherein the first locking portion and the second locking portion are configured to move relatively;
wherein movement of the second locking portion is configured to lock the second object onto the second clamping member; and
wherein movement of the first locking portion is configured to lock the movable end, enabling the clamping assembly to clamp the first object.

9. The interlocking locking assembly according to claim 8, wherein the first locking portion comprises a connecting rod and a pressing member;
wherein the connecting rod is hinged to the second locking portion, thereby achieving swingable connection of the first locking portion on the second locking portion;
wherein the pressing member is threadedly connected to the connecting rod, enabling relative convergent movement between the connecting rod and the pressing member by rotating the pressing member, thereby enabling relative convergent movement between the first locking portion and the second locking portion; and
wherein the pressing member is configured to press and cooperating with the movable end.

10. A truss, comprising a support column as a first object and a truss beam as a second object, wherein the truss beam is connected to the support column via an interlocking locking assembly; and
wherein the interlocking locking assembly is the interlocking locking assembly according to claim 1.

11. A workstation, comprising a truss and multiple storage platforms, wherein the truss is the truss according to claim 10; and
wherein the storage platforms are arranged in layers supported by support columns of the truss.
